(19) United States
(12) Patent Application Publication
(10) Pub. No.: US 2004/0043265 A1
(43) Pub. Date: Mar. 4, 2004

(54) Staged fuel cell with intercooling

(75) Inventors: Ronald Scott Bunker, Niskayuna, NY (US); Chellappa Balan, Niskayuna, NY (US)

Correspondence Address: General Electric Comapny, CRD Patent Docket Rm 4A59, P. O. Box 8, Bldg. K-1, Schenectady, NY, 12301, US

(73) Assignee: General Electric Company

(21) Appl. No.: 10/234,073

(22) Filed: Sep. 4, 2002

(51) Int. Cl. H01M 8/04; H01M 8/12; H01M 8/10; H01M 8/24

(52) U.S. Cl. 429/26; 429/30; 429/46; 429/38

(57) ABSTRACT

The present invention provides a staged fuel cell assembly comprising a plurality of fuel cells, each fuel cell being in fluid communication with at least one primary fluid delivery system; at least one heat exchanger, each heat exchanger being in fluid communication with the primary fluid delivery system disposed between adjacent fuel cells. The primary fluid delivery system, being in thermal communication with the at least one heat exchanger, delivers a primary fluid to the fuel cells. The present invention provides a method for thermal management of a staged fuel cell assembly. The method comprises delivering the primary fluid to the plurality of fuel cells where each fuel cell is in fluid communication with the at least one primary fluid delivery system.

### BACKGROUND OF TIE INVENTION

The present invention relates generally to a field of fuel cells and more particularly to the field of thermal management of a fuel cell stack or assembly.

In a wide variety of applications, a staged fuel cell stack such as a staged solid oxide fuel cell stack, have demonstrated a potential for high efficiency and low pollution in power generation. However, problems associated with thermal management of the staged fuel cell stacks persist, particularly pertaining to intercooling and preheating of the fluid between a fuel cell stack and an adjacent fuel cell stack. It is desirable that a fluid from an exit of the fuel cell stack of the staged fuel cell assembly undergoes intercooling before entering in the adjacent fuel cell stack of the staged fuel cell assembly. Additionally, the fluid entering the fuel cell stack of the staged fuel cell assembly needs to undergo preheating. Intercooling as well as preheating of the fluid is desirable to ensure uniform thermal potential of the staged fuel cell assembly architecture and provide internal fuel reforming. Accordingly, there is a need in the art to develop an improved thermal management system, which addresses issues pertaining to intercooling and preheating of the fluid handled by the staged fuel cell assembly.

### SUMMARY

The present invention provides a staged fuel cell assembly comprising a plurality of fuel cells, each fuel cell being in fluid communication with at least one primary fluid delivery system; at least one heat exchanger, each heat exchanger being in fluid communication with the primary fluid delivery system disposed between adjacent fuel cells. The primary fluid delivery system, being in thermal communication with the at least one heat exchanger, delivers a primary fluid to the fuel cells. The present invention provides a method for thermal management of a staged fuel cell assembly. The method comprises delivering the primary fluid to the plurality of fuel cells where each fuel cell is in fluid communication with the at least one primary fluid delivery system.

### BRIEF DESCRIPTION OF THE DRAWINGS

These and other features, aspects, and advantages of the present invention will become better understood with reference to the following description, appended claims, and accompanying drawings;

FIG. 1 is an exemplary cross sectional view of a staged fuel cell assembly according to one embodiment of the invention;

FIG. 2 is an exemplary cross sectional view of the staged fuel cell assembly with a secondary fluid delivery system according to another embodiment of the invention;

FIG. 3 is an exemplary cross sectional view of the staged fuel cell assembly with the secondary fluid delivery system and a supplemental fluid delivery system according to another embodiment of the invention;

FIG. 4 is an exemplary cross sectional view of the staged fuel cell assembly with another supplemental fluid delivery system according to another embodiment of the invention;

FIG. 5 is an exemplary cross sectional view of a staged fuel cell assembly with the secondary fluid delivery system and the supplemental fluid delivery system according to another embodiment of the invention;

FIG. 6 is an exemplary cross sectional view of a staged fuel cell assembly with a heat exchanger and the supplemental fluid delivery system according to another embodiment of the invention;

FIG. 7 is an exemplary cross sectional view of a staged fuel cell assembly with the secondary fluid delivery system, the heat exchangers and the supplemental fluid delivery system according to another embodiment of the invention; and

FIG. 8 is an exemplary cross sectional view of a staged fuel cell assembly with a pressure vessel according to another embodiment of the invention.

### DETAILED DESCRIPTION OF THE INVENTION

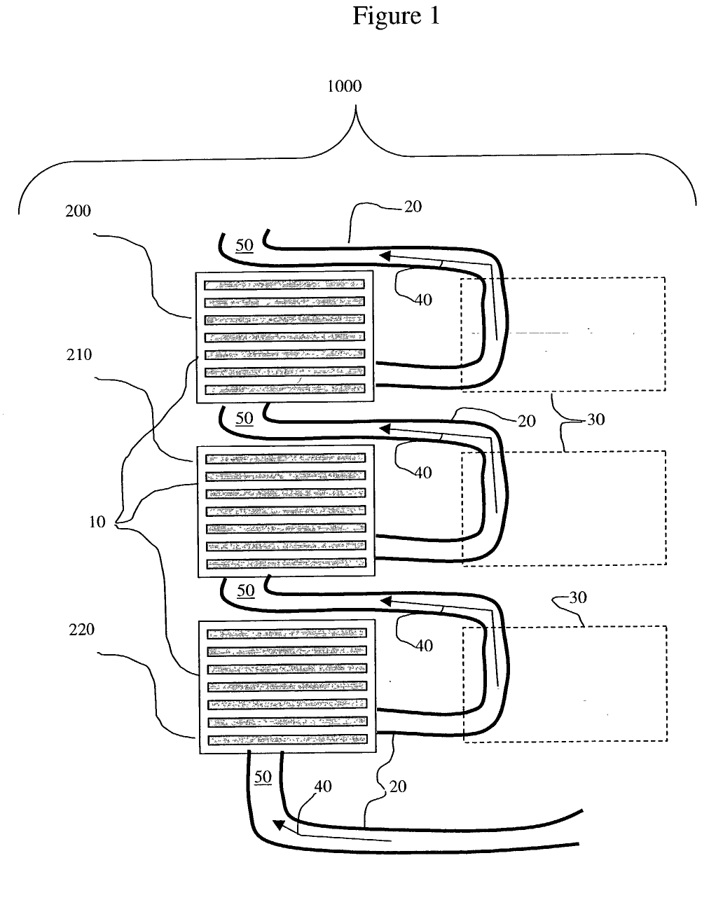

Referring to FIG. 1, one embodiment of the present invention illustrates a staged fuel cell assembly 1000, such as a solid oxide fuel cell assembly. The staged fuel cell assembly 1000 comprises a plurality of fuel cells 10 being stacked together either in series or in parallel to construct a fuel cell stack architecture. The plurality of fuel cells 10 is an energy conversion device, which produces electricity, by electrochemically combining a fuel and an oxidant across an ionic conducting layer.

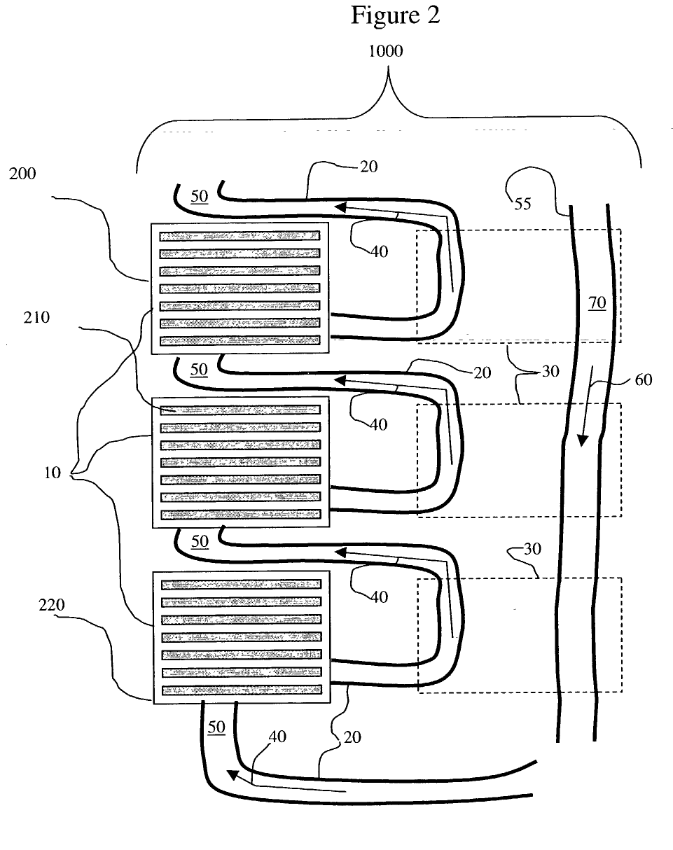

Referring to FIG. 1 and FIG. 2, the fuel cell stack architecture comprises exemplary modular fuel cell stacks 200, 210, 220. The staged fuel cell assembly 1000 in FIG. 1 comprises a plurality of fuel cells 10, each fuel cell 10 being in fluid communication with an at least one primary fluid delivery system 20); at least one heat exchanger 30, each heat exchanger 30 being in fluid communication with the primary fluid delivery system 20 between adjacent fuel cells 10. The primary fluid delivery system 20 is in thermal communication with the heat exchanger 30 to deliver a primary fluid 50 to the fuel cells 10.

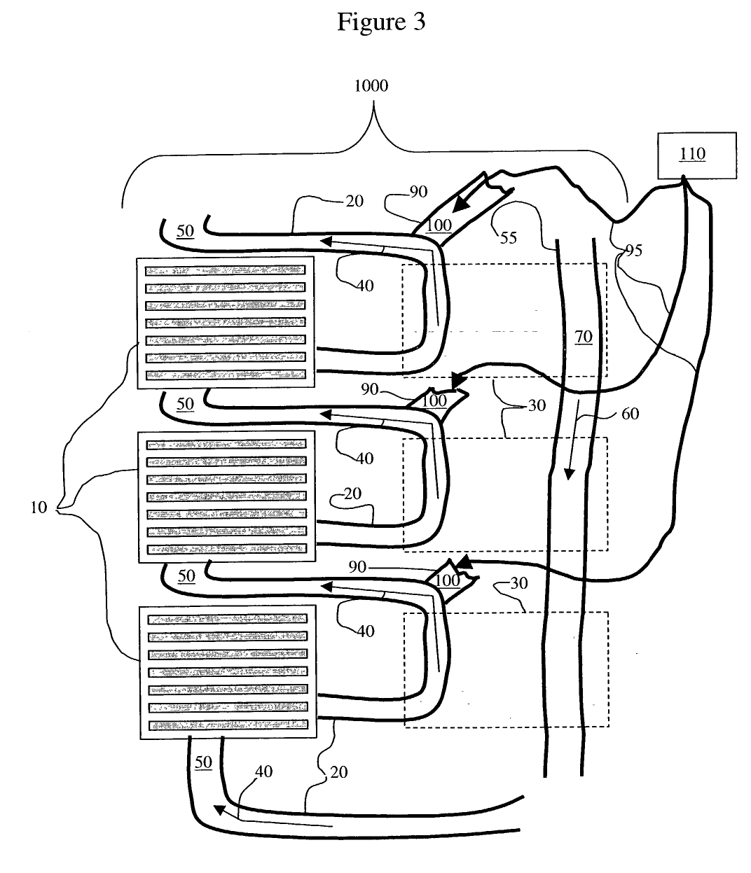

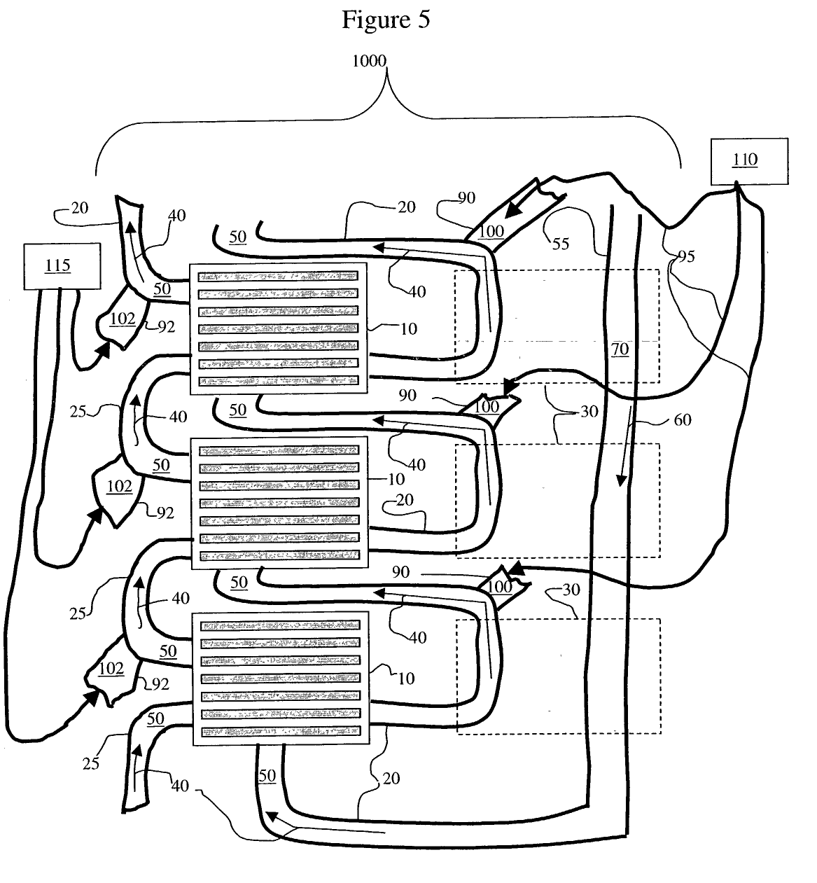

In one embodiment of the present invention, a secondary fluid delivery system 55 of FIG. 2 delivers a secondary fluid 70 to the heat exchanger 30. The secondary fluid 70 undergoes thermal exchange with the primary fluid 50. Referring to embodiments illustrated in FIGS. 3, and 5 7, each heat exchanger 30 further comprises a secondary fluid delivery system 55 to deliver a secondary fluid 70 for thermal exchange with the primary fluid 50. The secondary fluid 70 is selected from the group including, but not limited to fuel, oxidant, steam, and a fuel and steam mixture.

In the present invention, the term temperature conditioning is defined to include intercooling of the primary fluid 50 of FIG. 2 as well preheating of the primary fluid 50.

Heat transfer between the secondary fluid 70 of FIG. 2 and the primary fluid 50 intercools the primary fluid 50 when the primary fluid 50 enters into an exemplary fuel cell stack 210 from an adjacent fuel cell stack 200. In addition, thermal exchange of the secondary fluid 70 for example air, with a primary fluid 50 temperature conditions the primary fluid 50 before entering the staged fuel cell assembly 1000 when the primary fluid 50 and the secondary fluid 70 are same. Temperature conditioning the primary fluid 50 facilitates maintaining a desired temperature level of the primary fluid 50 before entering the staged fuel cell assembly 1000. Intercooling the primary fluid 50 between the adjacent fuel cell stacks, for example between the fuel cell stack 210 and an preceding fuel cell stack 200, beneficially provides maintaining uniform thermal potential across the staged fuel cell assembly 1000. Maintaining uniform thermal potential across the staged fuel cell assembly 1000 results in avoiding thermal hot spots at localized regions of the exemplary staged fuel cell assembly 1000. Additionally, appropriate temperature conditioning of the primary fluid 50 helps maintaining a desired uniform electrochemical reaction rate between the fuel and the oxidant across the exemplary fuel cell sub stacks 200, 210, 220 of the staged fuel cell assembly 1000. Uniform electrochemical reaction rate across the exemplary fuel cell sub stacks 200, 210, 220 beneficially provides steady, time independent, output power characteristics from the staged fuel cell assembly 1000.

In one embodiment of the present invention, when the primary fluid 50 and the secondary fluid 70 are independent, the degree of temperature conditioning of the primary fluid 50 is controlled by regulating the flow of the secondary fluid 70 to control the thermal exchange between the primary fluid 50 and the secondary fluid 70 in the heat exchanger 30. In another particular embodiment of the present invention, when the primary fluid 50 and the secondary fluid 70 are independent and the flow rate of the primary fluid 50 is restricted to that required for the staged fuel cell assembly 1000, the secondary flow 70 is controlled by a variable bypass flow control system (not shown in FIG. 2) to determine the temperature conditioning that occurs in the heat exchanger 30. In another specific embodiment of the present invention, when the primary fluid 50 and the secondary fluid 70 are the same fluid, then the primary fluid 50 and the secondary fluid 70 are both restricted in series unless there is some type of a bypass means provided to change the mass flow rate in the primary fluid 50 going through the heat exchanger 30.

Bypass means configurations are well known in the art and hence are not described in detail here. An artisan skilled in the art is left to determine the bypass means necessary to control both the temperature conditioning of the primary fluid 50 and the thermal exchange between the primary fluid 50 and the secondary fluid 70 in the heat exchanger 30.

Heat exchangers 30 are known and hence are not described in detail herein. According to one exemplary embodiment of the present invention, the heat exchanger 30 comprises at least one heat exchanger 30 of shell and tube configuration. In other embodiment of the present invention, the heat exchanger 30 comprises at least one heat exchanger 30 of plate and fin configuration.

In one exemplary embodiment of the present invention, a secondary fluid flow direction 60 in the secondary fluid delivery system 55 is antiparallel to a primary fluid flow direction 40 in the primary fluid delivery system 20. In other embodiment of the present invention, the secondary fluid flow direction 60 in the secondary fluid delivery system 55 is parallel to the primary fluid flow direction 40 in the primary fluid delivery system 20 (not shown in FIG. 2). In other embodiment of the present invention, the secondary fluid flow direction 60 in the secondary fluid delivery system 55 is orthogonal to the primary fluid flow direction 40 in the primary fluid delivery system 20 (not shown in FIG. 2). However, an artisan skilled in the art can select an appropriate heat exchanger 30 in accordance with appropriate heat exchangers design options as known in the art. Such appropriate heat exchanger design options pertain to factors such as, geometry of the heat exchanger 30 and fluid flow direction, for example, secondary fluid flow direction 60 relative to the primary fluid flow direction 40 in the heat exchanger 30. Choosing the appropriate heat exchanger design options for the appropriate heat exchanger 30 depends on optimization of limiting parameters of the heat exchanger 30 such as, thermal efficiency, and overall size.

The fuel cell 10 can be any type of fuel cell, including, but not limited to, a solid oxide fuel cell, a proton exchange membrane fuel cell, a molten carbonate fuel cell, a phosphoric acid fuel cell, an alkaline fuel cell, a direct methanol fuel cell, a regenerative fuel cell, a zinc air fuel cell, and a protonic ceramic fuel cell.

According to one embodiment of the present invention, the plurality of fuel cells 10, such as solid oxide fuel cells comprises at least one fuel cell 10 having a planar configuration. In other embodiment of the present invention, the plurality of fuel cells 10 comprises at least one fuel cell 10 having a tubular configuration.

According to one exemplary embodiment illustrated in FIG. 3, the primary fluid delivery system 20 is coupled to an at least one supplemental fluid source 110 by an at least one supplemental fluid delivery system 90. The supplemental fluid source 110 and the supplemental fluid delivery system 90 are configured to deliver a supplemental fluid 100 to the primary fluid delivery system 20. The supplemental fluid 100 supplied from the supplemental fluid source 110 ensures uninterrupted availability of the staged fuel cell assembly 1000. Ensuring uninterrupted availability of the staged fuel cell assembly 1000 is critical for uniform output power generation of the staged fuel cell assembly 1000 in response to factors such as fluctuating power demand, and failure of primary fluid delivery system 20. The supplemental fluid 100 is selected from the group including, but not limited to a fuel, an oxidant, a steam, and a fuel and steam mixture.

In one embodiment, the primary fluid delivery system 20, the supplemental fluid source 110, and the supplemental fluid delivery system 90 are configured to deliver the fuel to the fuel cell 10. In other embodiment, the primary fluid delivery system 20, the supplemental fluid source 110, and the supplemental fluid delivery system 90 are configured to deliver the steam to the fuel cell 10. In another embodiment, the primary fluid delivery system 20, the supplemental fluid source 110, and the supplemental fluid delivery system 90 are configured to deliver the oxidant to the fuel cell 10. Still in another embodiment, the primary fluid delivery system 20, the supplemental fluid source 110, and the supplemental fluid delivery system 90 are configured to deliver the fuel and steam mixture to the fuel cell 10).

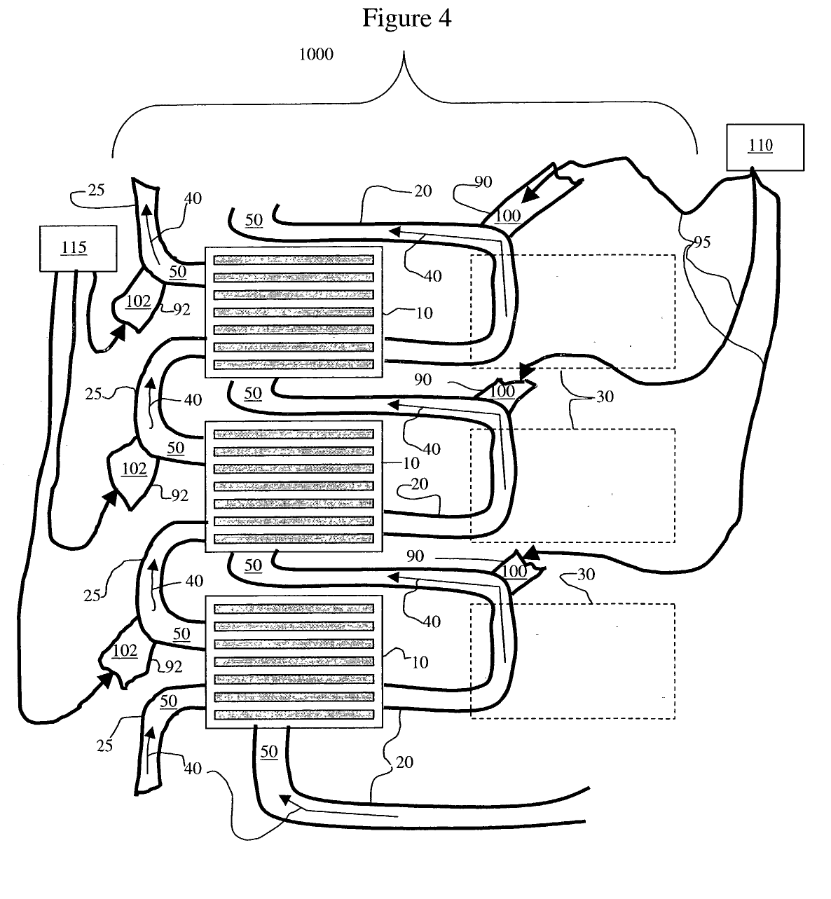

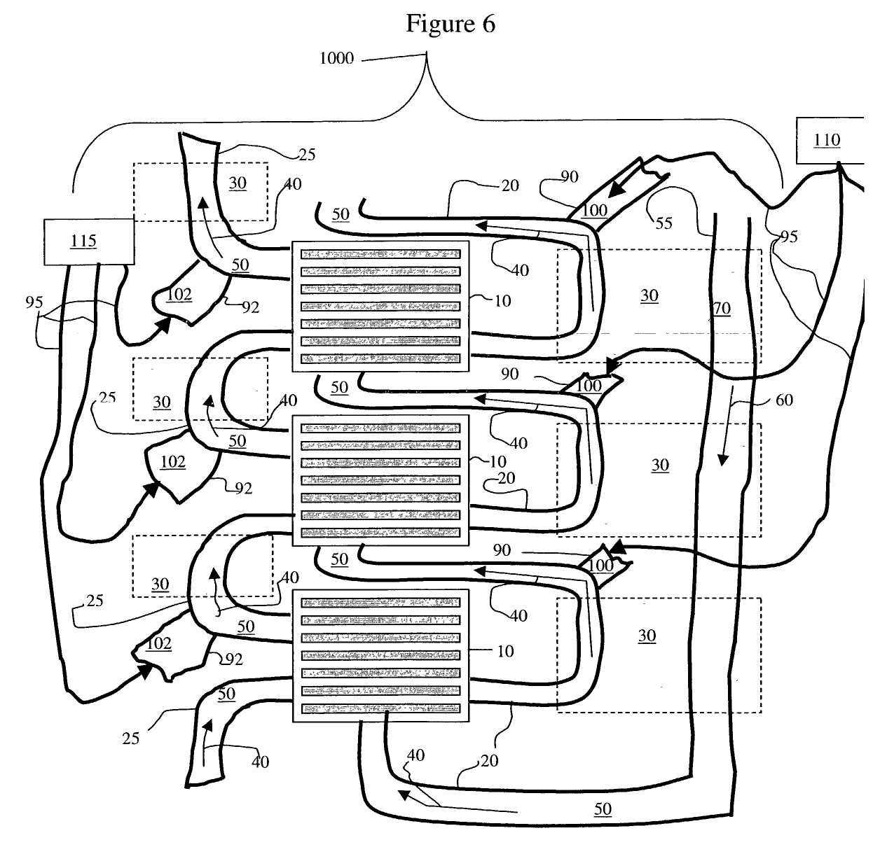

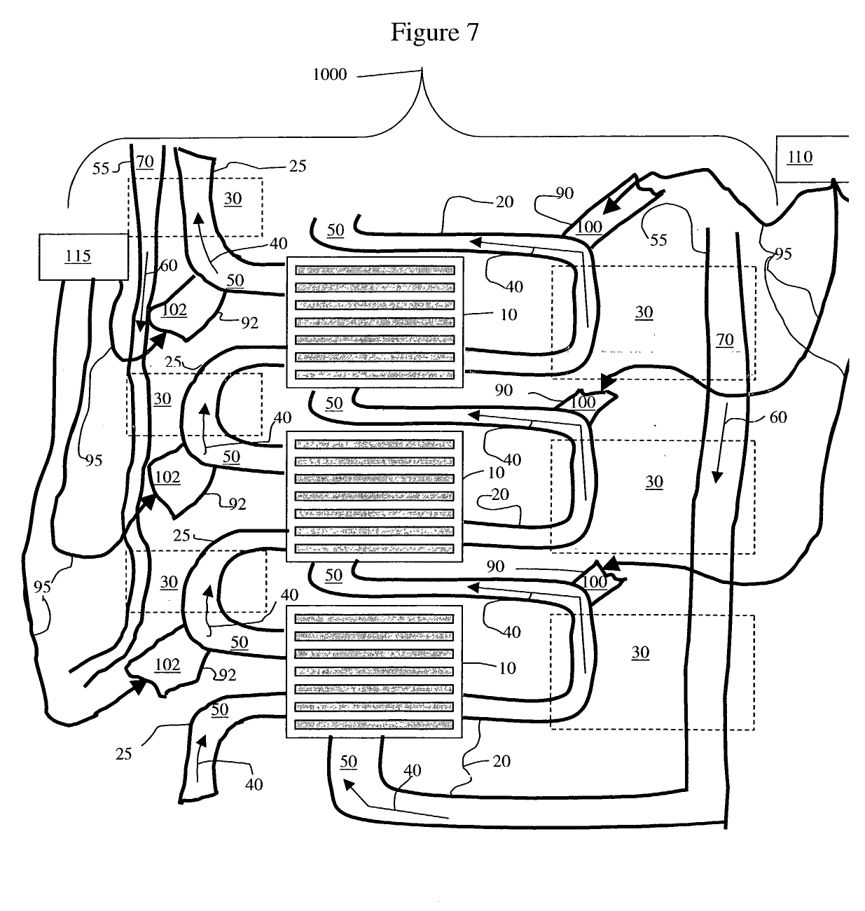

FIGS. 4 through 7 depict exemplary cross sectional views of the staged fuel cell assembly with another primary fluid delivery system 25 configured to deliver another primary fluid to the at least one fuel cell 10. FIGS. 4 through 7 also depict another supplemental fluid source 115, and another supplemental fluid delivery system 92 configured to deliver another supplemental fluid to the at least one fuel cell 10.

According to one exemplary embodiment of the present invention, one primary fluid delivery system 20, one supplemental fluid source 110, and one supplemental fluid delivery system 90 are configured to deliver the fuel to the at least one fuel cell 10, while another primary fluid delivery system 25, another supplemental fluid source 115, and another supplemental fluid delivery system 92 are configured to deliver the oxidant to the at least one fuel cell 10.

FIGS. 4-7 depict other embodiment of the present invention, where one primary fluid delivery system 20, one supplemental fluid source 110, and one supplemental fluid delivery system 90 are configured to deliver the fuel and steam mixture to the at least one fuel cell 10 while another primary fluid delivery system 25, another supplemental fluid source 115, and another supplemental fluid delivery system 92 are configured to deliver the oxidant to the at least one fuel cell 10.

FIGS. 5 through 7 represents an exemplary embodiment illustrating the secondary fluid 70 exit from the heat exchanger 30 while entering into primary fluid delivery system 20 forming a closed loop heat transfer system. Such closed loop heat transfer system substantially enhances thermodynamic effectiveness of the heat exchanger 30.

According to one embodiment of the present invention, the secondary fluid delivery system 55 of FIGS. 5-7 is configured to deliver the fuel to the heat exchanger 30, and the fuel exits from the heat exchanger 30 and enters the primary fluid delivery system 20. In another embodiment of the present invention, the secondary fluid delivery system 55 is configured to deliver the oxidant to the heat exchanger 30, and the oxidant exits from the heat exchanger 30 and enters the primary fluid delivery system 20. Yet, in another embodiment of the present invention, the secondary fluid delivery system 55 is configured to deliver the steam to the heat exchanger 30, and the steam exits from the heat exchanger 30 and enters the primary fluid delivery system 20. Still in another embodiment of the present invention, the secondary fluid delivery system 55 is configured to deliver the fuel and steam mixture to the heat exchanger 30, and the fuel and steam mixture exits from the heat exchanger 30 and enters the primary fluid delivery system 20. The artisan who is skilled in the art is left to select the desired combination of fuel, steam, fuel and steam mixture, and oxidant supplied to the fuel cells based on a specific operational characteristics desired and other design constraints such as space limitations. Likewise, the artisan who is skilled in the art is left to determine the final number and arrangement of the heat exchangers based on the specific application design requirements.

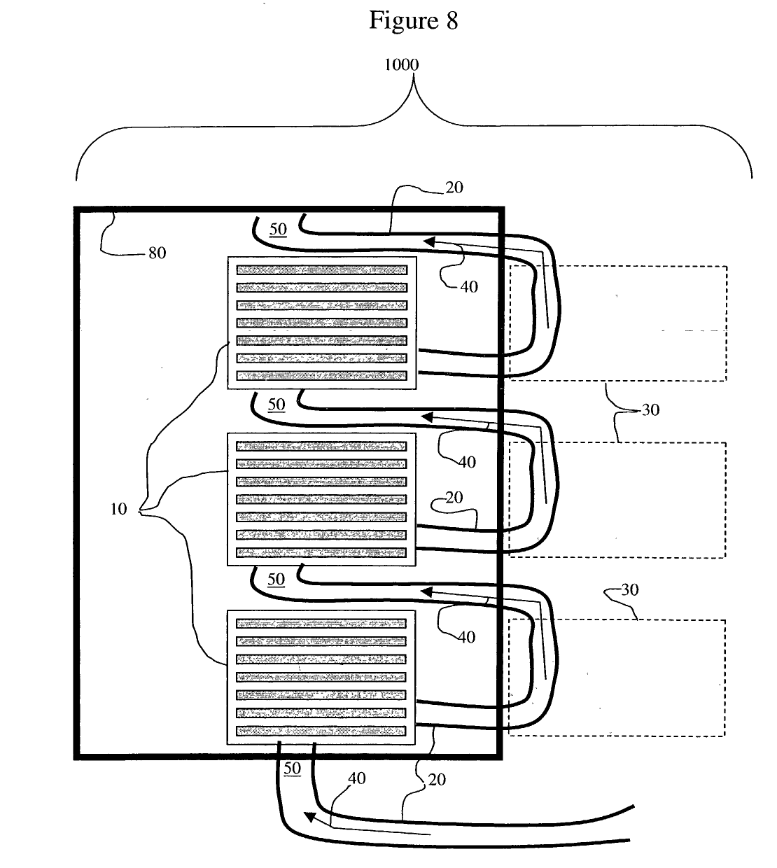

According to one embodiment of the present invention, illustrated in FIG. 8, the plurality of fuel cells 10 further comprises a pressure vessel 80 enclosing the fuel cells 10. In another embodiment of the present invention, the heat exchanger 30 is enclosed within the pressure vessel 80 not shown in FIG. 8.

A method embodiment of the present invention is provided for the thermal management of the staged fuel cell assembly 1000 of FIG. 1. The method comprises flowing at least one primary fluid 50 through a primary fluid delivery system 20 between a plurality of fuel cells 10, where the primary fluid delivery system 20 is in thermal communication with at least one heat exchanger.

Another method embodiment of the present invention is provided for the thermal management of the staged fuel cell assembly 1000 of FIG. 1. The method comprises flowing at least one primary fluid 50 through the primary fluid delivery system 20 between the plurality of fuel cells 10, where the primary fluid delivery system 20 is in thermal communication with the at least one heat exchanger. Additionally, the primary fluid delivery system 20 is coupled to the at least one supplementary fluid source 110 by the at least one supplemental fluid delivery system 90, to afford adding the at least one supplemental fluid 100 to the primary fluid 50.

A specific method embodiment of the present invention is provided for the thermal management of the staged fuel cell assembly 1000 of FIG. 1. The method comprises flowing the at least one primary fluid 50 through the primary fluid delivery system 20 between the plurality of fuel cells 10, where the primary fluid delivery system 20 is in thermal communication with the at least one heat exchanger 30. Additionally, the at least one heat exchanger 30 further comprises the secondary fluid delivery system 55, wherein the secondary fluid 70 is flowed through the secondary fluid delivery system 55 such that the secondary fluid 70 is in thermal exchange with the primary fluid 50.

Transferring heat between the primary fluid 50 of FIG. 2 and the secondary fluid 70 intercools the primary fluid 50 when the primary fluid 50 enters into an exemplary fuel cell stack 210 from a preceding fuel cell stack 200. Additionally, transferring heat between the primary fluid 50 and the secondary fluid 70 ensures temperature conditioning the primary fluid 50 before entering the staged fuel cell assembly 1000. Temperature conditioning the primary fluid 50 facilitates maintaining a desired temperature level of the primary fluid 50 before entering the staged fuel cell assembly 1000. Intercooling the primary fluid 50 between the adjacent fuel cell stacks, for example between the fuel cell stack 210 and the preceding fuel cell stack 200, beneficially maintains a uniform thermal potential of the staged fuel cell assembly 1000. Maintaining the uniform thermal potential of the staged fuel cell assembly 1000 results in avoiding thermal hot spots at localized regions of the exemplary staged fuel cell assembly 1000. Additionally, temperature conditioning of the primary fluid 50 helps maintain a desired uniform electrochemical reaction rate between the fuel and the oxidant across the exemplary fuel cell sub stacks 200, 210, 220 of the staged fuel cell assembly 1000. Uniform electrochemical reaction rate across the exemplary fuel cell sub stacks 200, 210, 220 beneficially results in steady time independent output power characteristics from the staged fuel cell assembly 1000. In one embodiment of the present invention, the degree of temperature conditioning of the primary fluid 50 is controlled by adjusting a thermal exchange rate between the primary fluid 50 and the secondary fluid 70 in the heat exchanger 30, when the secondary fluid 70 for example air is different from the primary fluid 50. In one specific embodiment of the present invention, adjusting the heat transfer rate between the primary fluid 50 and secondary fluid 70 is achieved by controlling the flow rate of the primary fluid 50 and the secondary fluid 70 across the heat exchanger 30.

Although only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A staged fuel cell assembly comprising:
plurality of fuel cells, each fuel cell being in fluid communication with an at least one primary fluid delivery system;
at least one heat exchanger, each heat exchanger being in fluid communication with said at least one primary fluid delivery system; and
said at least one primary fluid delivery system being disposed between adjacent fuel cells to deliver a primary fluid to said fuel cells, said at least one primary fluid delivery system being in thermal communication with said at least one heat exchanger.

2. The staged fuel cell assembly of claim 1, wherein said plurality of fuel cells further comprises a pressure vessel enclosing said fuel cells.

3. The staged fuel cell assembly of claim 2, wherein said heat exchanger is enclosed within said pressure vessel.

4. The staged fuel cell assembly in accordance with claim 1, wherein each of said plurality of fuel cells is selected from the group consisting of a solid oxide fuel cell, a proton exchange membrane fuel cell, a molten carbonate fuel cell, a phosphoric acid fuel cell, an alkaline fuel cell, a direct methanol fuel cell, a regenerative fuel cell, a zinc air fuel cell, and a protonic ceramic fuel cell.

5. The staged fuel cell assembly in accordance with claim 1, wherein said plurality of fuel cell comprises at least one fuel cell having a planar configuration.

6. The staged fuel cell assembly in accordance with claim 1, wherein said plurality of fuel cell comprises at least one fuel cell having a tubular configuration.

7. The staged fuel cell assembly in accordance with claim 1, wherein said heat exchanger is fluidically integral with a respective fuel cell.

8. The staged fuel cell assembly in accordance with claim 1, wherein said heat exchanger comprises at least one heat exchanger of shell and tube configuration.

9. The staged fuel cell assembly of claim 1, wherein said heat exchanger comprises at least one heat exchanger of plate and fin configuration.

10. The staged fuel cell assembly of claim 1, wherein an at least one primary fluid delivery system is coupled to an at least one supplemental fluid source by an at least one supplemental fluid delivery system.

11. The staged fuel cell assembly of claim 10, wherein said at least one supplemental fluid source and said at least one supplemental fluid delivery system are configured to deliver a supplemental fluid to said at least one primary fluid delivery system.

12. The staged fuel cell assembly of claim 11, wherein said supplemental fluid is selected from the group consisting of fuel, oxidant, steam, and a fuel and steam mixture.

13. The staged fuel cell assembly of claim 11, wherein said at least one primary fluid delivery system, said at least one supplemental fluid source, and said at least one supplemental fluid delivery system are configured to deliver said fuel to said at least one fuel cell.

14. The staged fuel cell assembly of claim 11, wherein said at least one primary fluid delivery system, said at least one supplemental fluid source, and said at least one supplemental fluid delivery system are configured to deliver said steam to said at least one fuel cell.

15. The staged fuel cell assembly of claim 11, wherein said at least one primary fluid delivery system, said at least one supplemental fluid source, and said at least one supplemental fluid delivery system are configured to deliver said oxidant to said at least one fuel cell.

16. The staged fuel cell assembly of claim 11, wherein said at least one primary fluid delivery system, said at least one supplemental fluid source, and said at least one supplemental fluid delivery system are configured to deliver said fuel and steam mixture to said at least one fuel cell.

17. The staged fuel cell assembly of claim 11, wherein one primary fluid delivery system, one supplemental fluid source, and one supplemental fluid delivery system are configured to deliver said fuel to said at least one fuel cell; wherein another primary fluid delivery system, another supplemental fluid source, and another supplemental fluid delivery system are configured to deliver said oxidant to said at least one fuel cell.

18. The staged fuel cell assembly of claim 11, wherein one primary fluid delivery system, another supplemental fluid source, and one supplemental fluid delivery system are configured to deliver said fuel and steam mixture to said at least one fuel cell; wherein another primary fluid delivery system, another supplemental fluid source, and another supplemental fluid delivery system are configured to deliver said oxidant to said at least one fuel cell.

19. The staged fuel cell assembly of claim 1, wherein each heat exchanger further comprises a secondary fluid delivery system to deliver a secondary fluid for thermal exchange with said primary fluid.

20. The staged fuel cell assembly of claim 19, wherein said secondary fluid is selected from the group consisting of fuel, oxidant, steam, and a fuel and steam mixture.

21. The staged fuel cell assembly in accordance with claim 20, wherein said secondary fluid delivery system is configured to deliver said fuel to said heat exchanger

22. The staged fuel cell assembly in accordance with claim 21, wherein said fuel exits from said heat exchanger and enters said primary fluid delivery system.

23. The staged fuel cell assembly in accordance with claim 20, wherein said secondary fluid delivery system is configured to deliver said oxidant to said heat exchanger.

24. The staged fuel cell assembly in accordance with claim 23, wherein said oxidant exits from said heat exchanger and enters said primary fluid delivery system.

25. The staged fuel cell assembly in accordance with claim 20, wherein said secondary fluid delivery system is configured to deliver said steam to said heat exchanger.

26. The staged fuel cell assembly in accordance with claim 25, wherein said steam exits from said heat exchanger and enters said primary fluid delivery system.

27. The staged fuel cell assembly in accordance with claim 20, wherein said secondary fluid delivery system is configured to deliver said fuel and steam mixture to said heat exchanger.

28. The staged fuel cell assembly in accordance with claim 27, wherein said fuel and steam mixture exits from said heat exchanger and enters said primary fluid delivery system.

29. The staged fuel cell assembly in accordance with claim 1, wherein a secondary fluid flow direction in said secondary fluid delivery system is antiparallel to said primary fluid flow direction in said primary fluid delivery system.

30. The staged fuel cell assembly in accordance with claim 1, wherein a secondary fluid flow direction in said secondary fluid delivery system is parallel to said primary fluid flow direction in said primary fluid delivery system.

31. The staged fuel cell assembly in accordance with claim 1, wherein a secondary fluid flow direction in said secondary fluid delivery system is orthogonal to said primary fluid flow direction in said primary fluid delivery system.

32. A staged fuel cell assembly comprising:
plurality of fuel cells, each fuel cell being in fluid communication with an at least one primary fluid delivery system;
at least one heat exchanger, each heat exchanger being in fluid communication with said at least one primary fluid delivery system; and
said at least one primary fluid delivery system being disposed between adjacent fuel cells to deliver a primary fluid to said fuel cells, said at least one primary fluid delivery system (20) being in thermal communication with said at least one heat exchanger,
wherein said at least one primary fluid delivery system is coupled to an at least one supplemental fluid source by an at least one supplemental fluid delivery system,
wherein said at least one supplemental fluid source and said at least one supplemental fluid delivery system are configured to deliver a supplemental fluid to said at least one primary fluid delivery system.

33. The staged fuel cell assembly of claim 32, wherein said supplemental fluid is selected from the group consisting of fuel, oxidant, steam, and a fuel and steam mixture.

34. The staged fuel cell assembly of claim 32, wherein said at least one primary fluid delivery system, said at least one supplemental fluid source, and said at least one supplemental fluid delivery system are configured to deliver said fuel to said at least one fuel cell.

35. The staged fuel cell assembly of claim 32, wherein said at least one primary fluid delivery system, said at least one supplemental fluid source, and said at least one supplemental fluid delivery system are configured to deliver said steam to said at least one fuel cell.

36. The staged fuel cell assembly of claim 32, wherein said at least one primary fluid delivery system, said at least one supplemental fluid source, and said at least one supplemental fluid delivery system are configured to deliver said oxidant to said at least one fuel cell.

37. The staged fuel cell assembly of claim 32, wherein said at least one primary fluid delivery system, said at least one supplemental fluid source, and said at least one supplemental fluid delivery system are configured to deliver said fuel and steam mixture to said at least one fuel cell.

38. The staged fuel cell assembly of claim 32, wherein one primary fluid delivery system, one supplemental fluid source, and one supplemental fluid delivery system are configured to deliver said fuel to said at least one fuel cell; wherein another primary fluid delivery system, another supplemental fluid source, and another supplemental fluid delivery system are configured to deliver the oxidant to said at least one fuel cell.

39. The staged fuel cell assembly of claim 32, wherein one primary fluid delivery system, another supplemental fluid source, and one supplemental fluid delivery system are configured to deliver said fuel and steam mixture to said at least one fuel cell; wherein another primary fluid delivery system, another supplemental fluid source, and another supplemental fluid delivery system are configured to deliver said oxidant to said at least one fuel cell.

40. A staged fuel cell assembly comprising:
plurality of fuel cells, each fuel cell being in fluid communication with an at least one primary fluid delivery system;
at least one heat exchanger, each heat exchanger being in fluid communication with said at least one primary fluid delivery system; and
said at least one primary fluid delivery system being disposed between adjacent fuel cells to deliver a primary fluid to said fuel cells, said at least one primary fluid delivery system being in thermal communication with said at least one heat exchanger,
wherein each heat exchanger further comprises a secondary fluid delivery system to deliver a secondary fluid for thermal exchange with said primary fluid,
wherein said secondary fluid delivery system is configured to deliver said secondary fluid to said heat exchanger,
wherein said secondary fluid is selected from the group consisting of fuel, oxidant, steam, and a fuel and steam mixture.

41. The staged fuel cell assembly in accordance with claim 40, wherein said fuel exits from said heat exchanger and enters said primary fluid delivery system.

42. The staged fuel cell assembly in accordance with claim 40, wherein said secondary fluid delivery system is configured to deliver said oxidant to said heat exchanger.

43. The staged fuel cell assembly in accordance with claim 42, wherein said oxidant exits from said heat exchanger and enters said primary fluid delivery system.

44. The staged fuel cell assembly in accordance with claim 40, wherein said secondary fluid delivery system is configured to deliver said steam to said heat exchanger.

45. The staged fuel cell assembly in accordance with claim 44, wherein said steam exits from said heat exchanger and enters said primary fluid delivery system.

46. The staged fuel cell assembly in accordance with claim 40, wherein said secondary fluid delivery system is configured to deliver said fuel and steam mixture to said heat exchanger.

47. The staged fuel cell assembly in accordance with claim 46, wherein said fuel and steam mixture exits from said heat exchanger and enters said primary fluid delivery system.

48. A method for thermal management of a staged fuel cell assembly, said method comprising:
delivering a primary fluid to a plurality of fuel cells,
wherein each fuel cell is in fluid communication with an at least one primary fluid delivery system,
wherein said at least one primary fluid delivery system is in thermal communication with at least one heat exchanger,
wherein said at least one primary fluid delivery system is disposed between adjacent fuel cells.

49. A method for thermal management of a staged fuel cell assembly, said method comprising:
delivering a primary fluid to a plurality of fuel cells; and
delivering a supplemental fluid to said at least one primary fluid delivery system,
wherein each fuel cell is in fluid communication with said at least one primary fluid delivery system,
wherein said at least one primary fluid delivery system is in thermal communication with at least one heat exchanger,
wherein said at least one primary fluid delivery system is disposed between adjacent fuel cells,
wherein said at least one primary fluid delivery system is coupled to an at least one supplemental fluid source by an at least one supplemental fluid delivery system.

50. A method for thermal management of a staged fuel cell assembly, said method comprising:
delivering a primary fluid to a plurality of fuel cells; and
delivering a secondary fluid for thermal exchange with said primary fluid,
wherein each fuel cell is in fluid communication with an at least one primary fluid delivery system,
wherein said at least one primary fluid delivery system is in thermal communication with at least one heat exchanger,
wherein said at least one primary fluid delivery system is disposed between adjacent fuel cells,
wherein said at least one heat exchanger further comprises a secondary fluid delivery system,
wherein said secondary fluid delivery system is configured to deliver said secondary fluid to said heat exchanger.
